(19) United States
(12) Patent Application Publication
(10) Pub. No.: US 2005/0144637 A1
(43) Pub. Date: Jun. 30, 2005

(54) Signal output method and channel selecting apparatus

(75) Inventors: Yasushi Shikata, Sagamihara-shi (JP); Kazuna Maruyama, Tokyo (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha

(21) Appl. No.: 11/008,268

(22) Filed: Dec. 10, 2004

(30) Foreign Application Priority Data
Dec. 26, 2003 (JP) 2003-435664(PAT.)
Nov. 30, 2004 (JP) 2004-345330(PAT.)

(51) Int. Cl. H04N 7/16; G06F 13/00; H04N 5/445; G06F 3/00; H04N 7/10; H04N 7/025

(52) U.S. Cl. 725/35; 725/37; 725/135; 725/32; 725/46

(57) ABSTRACT

A signal output method of outputting an image signal for displaying an image, comprises: a selection step of selecting a channel according to a signal for giving an instruction of changing a channel; and an output step of outputting an image signal for displaying other image when an image of the channel selected at the selection step is an image that is not an image constructing a program. The “other image” includes information related to a program which is outputted or scheduled to be outputted by the channel selected. Which channel is selected at the selection step is determined on the basis of information related to a usage history of an apparatus having a device for performing the selection step.

### BACKGROUND OF THE INVENTION

1. Field of the Invention

The present invention relates to a technology of selecting a channel on the basis of user's preference information.

2. Description of the Related Art

When a viewer retrieves a desired television (TV) program from a group of TV programs which are presently being broadcasted, the most-familiar and frequently-used method is a method of selecting a channel by using an up/down key or ten keys of a remote controller to find a program while directly viewing programs. In the channel selection with the up/down key, the retrieval order is the order of channels. In the channel selection with the ten keys, a channel is assigned to each of the keys, so that the retrieval order is an order of selection of the ten keys by the viewer. The viewer finds a desired program by using any of the methods (hereafter, an operation of searching a desired program while switching a program to be displayed will be called “zapping”).

In recent years, because of digitalization of broadcasting, the number of viewable programs is increasing. For the viewers, it provides an advantage that the number of interesting programs increases. On the other hand, however, the zapping operation has a problem such that a complicated operation is necessary to find a desired program. In zapping using the up/down key, when the number of channels increases, the number of operations required for zapping increases. In zapping using the ten-key pad, although an operation similar to conventional one can be performed to select any of the channels assigned to the keys, in the case of zapping channels which are not assigned to the keys, a complicated operation has to be performed. Another method of finding a program is a method using an EPG (Electronic Program Guide). The EPG usually has a simple sorting function and is suitable for finding a program in some aspects. However, since the EPG is a method of retrieving mainly characters, for viewers who find a program by a conventional method of viewing mainly pictures, it cannot be always the that the method is easy to use.

In such circumstances, the present inventor has studied a zapping method with the up/down key, in which the user's preference is reflected. According to the method, preference of a viewer is estimated from history information of programs viewed by the viewer, and is used for zapping. Specifically, the order of selection is set to not the order of channels but the order of programs from the highest preference of the viewer. If the preference of the viewer is accurately reflected in the order, the viewer can relatively easily find a desired program by an operation similar to conventional one.

In Japanese Unexamined Patent Publication No. 2000-253325, to make a user select and view a desired channel with efficiency and with precision from among many channels is proposed as a problem. A technology of displaying a recommendation program table that displays a group of programs meeting user's preference in a display unit by two-dimensional expression of a time axis and a recommendation axis is disclosed as means for solving the problem.

Japanese Unexamined Patent Publication No. 2001-275090 disclosed the following technology: when an event (for example, commercial message (CM)) is detected during the viewing of a program, the present channel is switched to a channel of the longest viewing time with reference to history information and when an event (CM) is detected also in the switched channel, the channel is further switched to a channel of the next history (see paraphrase 27 and FIG. 7 in the above publication).

### SUMAMRY OF THE INVENTION

Even if a channel is selected on the basis of a usage history (user's preference information), there are cases where an image transmitted by the selected channel is not an image constructing a TV program and an image that is not an image constructing the TV program comes to be displayed.

The object of the present invention is to prevent a screen from being brought to a state where only an image that is not an image constructing a TV program is displayed.

According to the first aspect of the invention, there is provided a signal output method of outputting an image signal to display an image, the method including: a selection step of selecting a channel according to a signal for giving an instruction of changing a channel; and an output step of outputting an image signal for displaying other image when an image of the channel selected at the selection step is an image that is not an image constructing a program. The “other image” includes information related to a program which is outputted or scheduled to be outputted by the channel selected. Which channel is selected at the selection step is determined on the basis of information related to a usage history of an apparatus having a device for performing the selection step.

### BRIEF DESCRIPTION OF THE DRAWINGS

FIG. 1 is a block diagram to show the construction of a receiving apparatus 10 according to the first and second embodiments of the invention,

FIG. 2 is an illustration to show the relationship between various kinds of information stored in a storing unit 107 according to the first and second embodiments of the invention and respective parts for storing the information,

FIG. 3 is a construction example of keys on a remote controller 20 according to the first, second, and third embodiments of the invention,

FIG. 4 shows display examples of screen transition in order of channel number when the up/down key of the remote controller 20 is pressed down,

FIG. 5 shows display examples of screen transition in decreasing order of viewer's preference when the up/down key of the remote controller 20 is pressed down,

FIG. 6 is a flow chart of a channel selection processing according to the first embodiment of the invention,

FIG. 7 is a flow chart of the channel selection processing according to the first embodiment of the invention,

FIG. 8 is a flow chart of the channel selection processing according to the first embodiment of the invention,

FIG. 9 is a zapping list example according to an embodiment of the invention,

FIG. 10 is a display example when some programs are in CM in FIG. 5,

FIG. 11 is a display example in the channel selection processing according to the first embodiment of the invention,

FIG. 12 is a flow chart of a channel selection processing according to the first embodiment of the invention,

FIG. 13 is another display example in the channel selection processing according to the first embodiment of the invention,

FIG. 14 is a block diagram to show the construction of a receiving apparatus 10 according to the second embodiment of the invention,

FIG. 15 is an illustration to show the relationship between various kinds of information stored in a storing unit 107 according to the second embodiment of the invention and respective parts for storing the information,

FIG. 16 is a display example in a channel selection processing according to the second embodiment of the invention,

FIG. 17 is a flow chart of the channel selection processing according to the second embodiment of the invention,

FIG. 18 is a flow chart of the channel selection processing according to the second embodiment of the invention,

FIG. 19 is a flow chart of the channel selection processing according to the second embodiment of the invention, and

FIG. 20 is a display example in the channel selection processing according to the second embodiment of the invention.

### DESCRIPTION OF THE PREFERRED EMBODIMENTS

A method of utilizing preference information or history information is effective for accessing a desired TV program with relative ease by a conventional zapping operation even in a multi-channel environment. On the other hand, a zapping method that mainly uses images presents some problems even now. One of the problems is the difficulty of grasping the contents of a TV program at the time of zapping. Usually, in the zapping operation, a plurality of programs is viewed for a certain short period. For example, within a period during which CM (the commercial message) of a program that the viewer is viewing is on the air, in order to check the other programs, the viewer changes other channels in rapid succession. In this case, when a CM is on the air also in the other channel or even when a program is on the air, if the image is too difficult for the viewer to grasp the contents of the program, the viewer has difficulty in judging whether or not the program is interesting to himself. In particular, when the viewer performs the zapping operation in order of the decreasing degree of viewer's preference especially in a multi-channel environment, it is thought that the viewer does not previously recognize what the destination channel of selection is and hence the viewer has difficulty in judging only from the image whether or not the program is interesting to himself and why the program is selected as the destination channel.

Hence, the present inventors made a diligent study of a method of making it possible for a user to grasp the contents of a selected program with more relative ease when programs are displayed in the order determined on the basis of information related to the degree of user's preference.

Hereafter, the embodiments of the invention will be described with reference to the drawings.

### First Embodiment

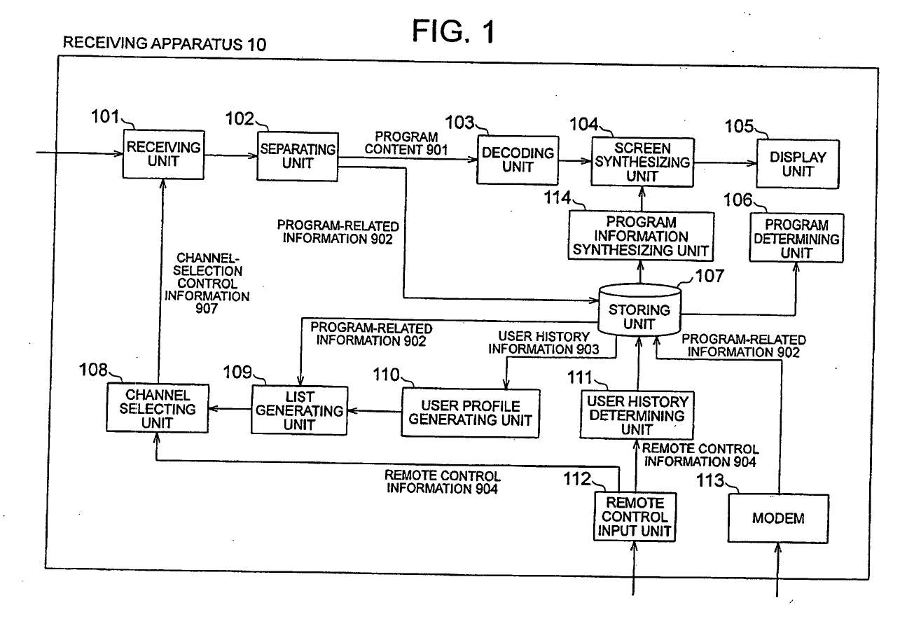

FIG. 1 is a block diagram to show the construction of a receiving apparatus (channel selecting apparatus) 10 according to the first embodiment of the invention.

This receiving apparatus 10 can receive a digital broadcast or an analog broadcast via a receiving unit 101. Broadcast data received by the receiving unit 101 is demodulated and then sent to a separating unit 102.

The separating unit 102 separates the multiplexed broadcast data. An AV stream constructing the program such as images and voices (hereinafter referred to as “program content 901”) is separated and then sent to a decoding unit 103. In the case where information related to the program (hereinafter referred to as “program-related information 902”) exists in the broadcast data, the separating unit 102 separates the information from the program content 901 and then sends the information to a storing unit 107. The program-related information 902 includes not only the same contents as the program information included in SI (service information) transmitted in a manner multiplexed in BS broadcast data but also related information for each scene of the program (hereinafter referred to as “program scene information”).

Here, the “scene” is such that divides a program into meaningful units in contents and the lengths (periods) of the respective scenes are different from each other. The program scene information holds information related to the respective scenes of the program. The information related to the scene includes, for example, the identification information of each scene, the starting time of each scene, the length (period) of the scene, general description, a keyword related to the scene, a link to the related information, and the like. The starting time of the scene and the length (period) of the scene is specified by time in some case and by the number of frames of image in the other case. The program scene information like this can be also utilized to search the scene of the program and to view the digest of the program. Further, the program scene information includes information to show whether or not each scene shows the contents of the program. For this reason, a scene including an image showing the contents of the program is differentiated from a scene including an image not showing the contents of the program such as CM. All information described above does not need to be included essentially in all program scene information. For example, in the program of soccer, the program scene information of a scene that possibly becomes a highlight of the program, for example, a goal scene includes much information but the program scene information of the other scenes includes relatively little information or does not include any information at all. However, even in the latter case, when the scene concerned does not show the contents of the program, it is assumed that the program scene information includes some information to show that.

Usually, the program-related information 902 of the program until about one week in the future is stored in the storing unit 107. Depending on the program, the contents of the program are not fixed all this while immediately before the program is broadcast, so that it is thought that the program-related information 902 and the program scene information thereof are very much limited. For this reason, the above-described information can be dynamically updated at any time even when the program concerned is on the air, and the separating unit 102 monitors update information included in the program-related information 902 and updates the program-related information 902 before update, which is stored in the storing unit 107, and the program scene information included in the program-related information 902 when it turned out that the program-related information is renewed by the above-described information.

The decoding unit 103 decodes the program content 901 separated by the separating unit 102 and passes motion image information of the program content 901 to a screen synthesizing unit 104. Similarly, the decoding unit 103 passes the sound information of the program content 901 to an audio output unit (not shown). The screen synthesizing unit 104 combines the motion image information received from the decoding unit 103 with the information of still images and character figures received from a program information synthesizing unit 114 or switches between these two information. In the case of viewing TV usually, the screen synthesizing unit 104 passes the motion image information in the program content 901 received from the decoding unit 103 to a display unit 105. On the other hand, in the case of displaying EPG and information showing the contents of the program, the screen synthesizing unit 104 combines the information of still images and character figures acquired from the program information synthesizing unit 114 with the motion image information and passes the combined information to the display unit 105. The display unit 105 outputs the combined result from the screen synthesizing unit 104 on the screen to provide the result to the viewer. Similarly, the audio output unit also outputs the acquired sound information in synchronization with the motion images.

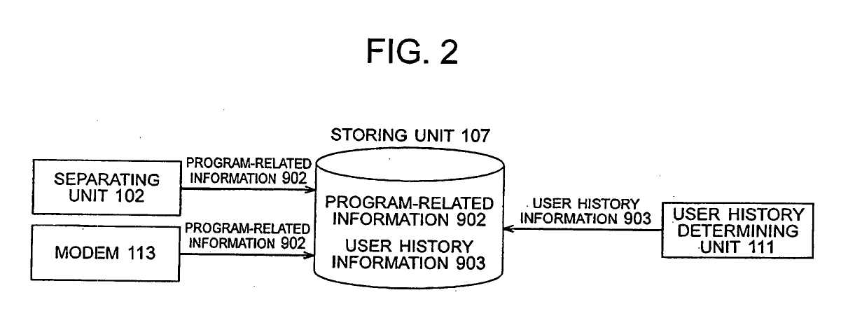

The storing unit 107 stores the program-related information 902 and history information (hereinafter referred to as “user history information 903”) of the programs viewed by the viewer, which will be described later. In FIG. 2 is shown the relationship between various kinds of information stored in the storing unit 107 and the respective parts storing the information. The storing unit 107 is thought to be a hard disk or a semiconductor memory but is not limited to them. Here, the receiving apparatus 10 has a modem 113. The program-related information 902 exists in a specific site on the Internet in some case and in this case, the receiving apparatus 10 is connected to the Internet via the modem 113 and can also download the program-related information 902. The program-related information 902 acquired via the modem 113 is also stored in the storing unit 107.

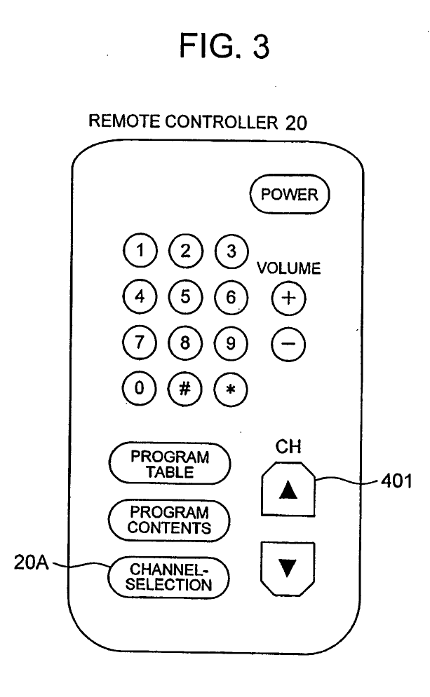

The viewer uses a remote controller 20 as operating means when viewing the program. The construction example of keys on the remote controller 20 is shown in FIG. 3. The remote controller 20 includes at least a power key, a ten-key, a key for regulating a sound level (volume), and an up/down key 401. Further, the remote controller 20 includes a channel-selection switching key 20A for switching the order of selecting channels at the time of performing a zapping operation by pressing down the up/down key 401 between the usual order of channel number and the decreasing order of viewer's preference. Remote control information 904 produced by the viewer pressing down the remote control key is received by a remote control input unit 112. When this remote control information 904 is information related to the selection of channel, the remote control input unit 112 passes the remote control information 904 to a channel selecting unit 108. Usually, the information related to the selection of channel means information which occurs when the up/down key or the ten-key provided on the remote controller 20 is pressed down, but is not limited to it. The information related to the selection of channel includes also the selection of channel via EPG. When the channel selecting unit 108 receives the remote control information 904, it outputs channel-selection control information 907 according to the remote control information 904 to the receiving unit 101. The receiving unit 101 performs tuning to a channel specified by the channel-selection control information 907. The tuning to this specified channel corresponds to the selection of a signal path and the selection of a distribution source. On the other hand, the remote control information 904 is sent also to a user history determining unit 111 via the remote control input unit 112. The user history determining unit 111 generates user history information 903 that is a viewer's program viewing, history from the program-related information 902 stored in the storing unit 107 and stores the user history information 903 in the storing unit 107.

A user profile generating unit 110 generates a user profile that is user's program preference information. When the user profile is generated, not only information that is previously set in the receiving apparatus 10 and shows user's preference such as a program key word inputted by the viewer but also the user history information 903 stored in the storing unit 107 is used.

A list generating unit 109 generates a zapping list 906 on the basis of the user profile and the program-related information 902 stored in the storing unit 107. The zapping list 906 is a list in which a group of programs broadcast during a specific time period are arranged in order of the decreasing degree of user's preference. The specific time period means a time period during which a certain program is broadcast and an update interval of the user profile. For this reason, every time one program now on the air is ended and a new program starts, the list generating unit 109 updates the zapping list 906. Similarly, every time the user profile generating unit 110 updates the user profile, the list generating unit 109 regards the user's preference as having changed and updates the zapping list 906. That is, the list generating unit 109 is means for determining the order of selecting channels in the zapping operation.

When the channel selecting unit 108 receives the remote control information 904 related to the selection of channel, it outputs the channel-selection control information 907 according to the zapping list 906 to the receiving unit 101. For example, when the viewer performs a zapping operation by the up/down key 401 of the remote controller 20, the channel selecting unit 108 makes, to the receiving unit 101, not a request to select channels in order of channel number but a request to select a channel that broadcasts a program of higher degree of user's preference based on the zapping list 906. The channel selecting unit 108 sends the information of the selection of channel also to the user history determining unit 111. The user history determining unit 111 usually generates the user history information 903 from the remote control information 904 and the program-related information 902, but when the user history determining unit 111 receives the information of the selection of channel from the channel selecting unit 108, the user history determining unit 111 generates the user history information 903 on the basis of the information of the selection of channel and the program-related information.

A program determining unit 106 determines whether or not the image of the program now on the air shows the contents of the program. A determination method utilizes program scene information included in the program-related information 902. The program determining unit 106 specifies and acquires program scene information corresponding to the image being now provided to the display unit 105 from among the program-related information 902. Thereafter, the program determining unit 106 makes the determination by extracting information to show whether or not the image concerned shows the contents of the program (in other words, whether or not the image concerned is an image constructing the program) from the acquired program scene information.

The program information synthesizing unit 114 acquires information related to the specified program from the program-related information 902 stored in the storing unit 107 and then generates character figure information to be displayed by the display unit 105. Further, thereafter, the program information synthesizing unit 114 makes a request to combine the information with the other motion image and to output the combined information to the screen synthesizing unit 104. In this regard, the program information synthesizing unit 114 acquires the reason of recommendation of the program (reason why the program is at a higher level in the list) specified by the list generating unit 109, if necessary, and then generates character figure information in the similar manner described above and makes a request to combine the character figure with the other motion image and to output the combined information to the screen synthesizing unit 104.

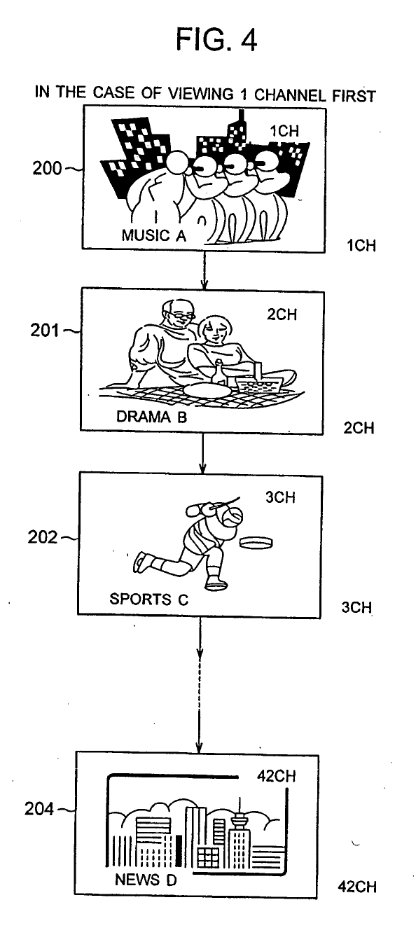

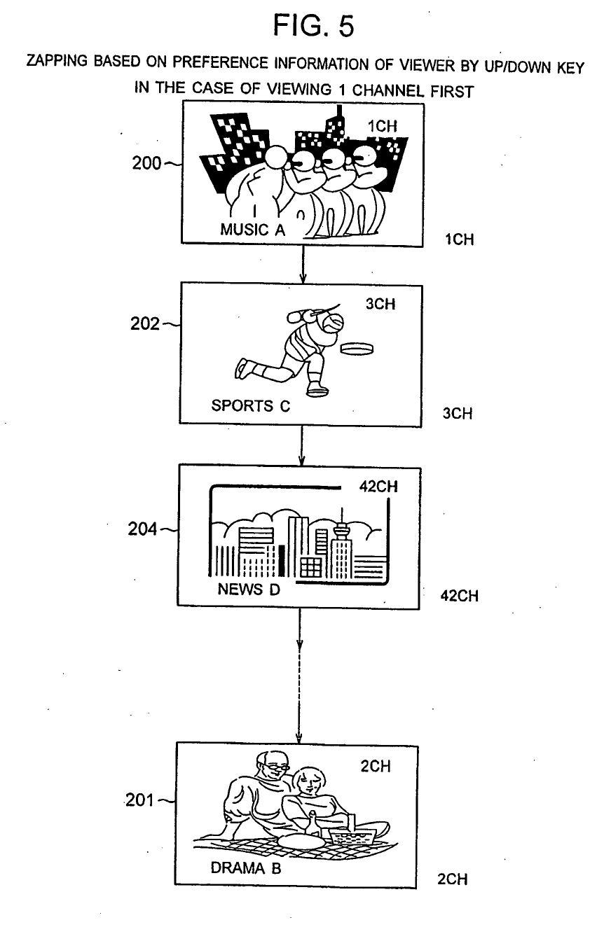

Next, a channel selection processing (signal output method) by the receiving apparatus 10 will be described. In FIG. 4 is shown the state of screen transition when the up/down key.401 of the remote controller 20 is pressed down continuously (in other words, when the zapping operation is performed). Here, a case is thought where the viewer is first viewing the image 200 of a music program of a channel number 1. In this case, when the viewer presses down the down key (or the up key) of the remote controller 20, the screen transits from the image 200 of the channel number 1 to the image 201 of a channel number 2 and the image 202 of a channel number 3. Depending on the receiving apparatus, there is a case where a channel not showing an image is automatically skipped, but channels are basically selected in order of channel number. Next, in FIG. 5 is shown the state of screen in the case of selecting a channel based on the information of viewer's preference. Although the same remote control operation as described above is performed, the channel is selected not in order of channel number but in order of the decreasing degree of viewer's preference, so that the channel is selected not in order of selected channel but in irregular order. In FIG. 5, when the viewer presses down the down key (or up key) of the up/down key 401 while viewing the image 200 of program of the channel number 1, the screen transits from the image 200 of the channel number 1 to the image 202 of the channel number 3 and the image 204 of a channel number 42.

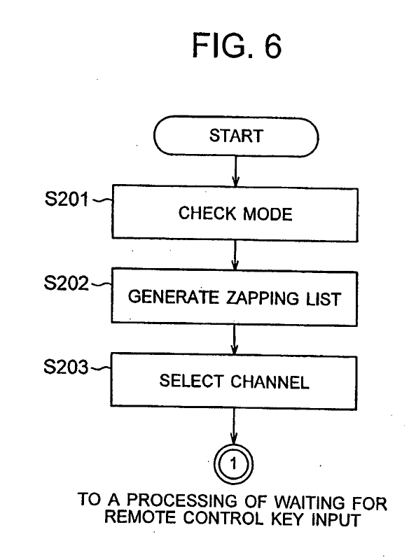

Hereafter, a zapping processing based on the viewer's preference shown in FIG. 5 will be described by the use of FIGS. 6, 7, and 8.

FIG. 6 is a processing flow from the starting of the receiving apparatus 10 to the providing of the first TV program. When the viewer starts the receiving apparatus 10, the receiving apparatus 10 checks a mode (step S201 in FIG. 6). There exists a plurality of modes according to difference in order of the selection of channels at the time of zapping operation by pressing down the up/down key 401. One of the modes is a usual channel-selection mode in order of the channel number and another mode is a channel-selection mode in order of the decreasing degree of viewer's preference. Here, in the case of the latter mode, the list generating unit 109 in the receiving apparatus 10 acquires a user profile from the user profile generating unit 110 and the program-related information 902 from the storing unit 107 and generates the zapping list 906 (FIG. 6, step S202). The list is generated by extracting a corresponding group of programs from the program-related information 902 and by arranging the extracted group of programs in order of the decreasing degree of viewer's preference on the basis of the user profile. The programs to become objects for the production of the list may include the program now on the air and a program scheduled to be started in a few minutes. For example, many programs start at round times such as 17:00 and 17:30 and when the viewer starts the receiving apparatus 10 at 16:56, it is also recommended that not only the program on the air at that time but also a program scheduled to be started in a few minutes (here, 17:00) be an object for the production of the list. However, when the viewer selects a channel according to the list, in the case where a channel of the program scheduled to be started in a few minutes is selected, the viewer is provided with notification of the effect that the corresponding program is not yet started. It is also preferable to display the name of a program to be started in a few minutes on the display screen. In addition, it is also preferable to display the detailed information of the program such as contents and genre of the program.

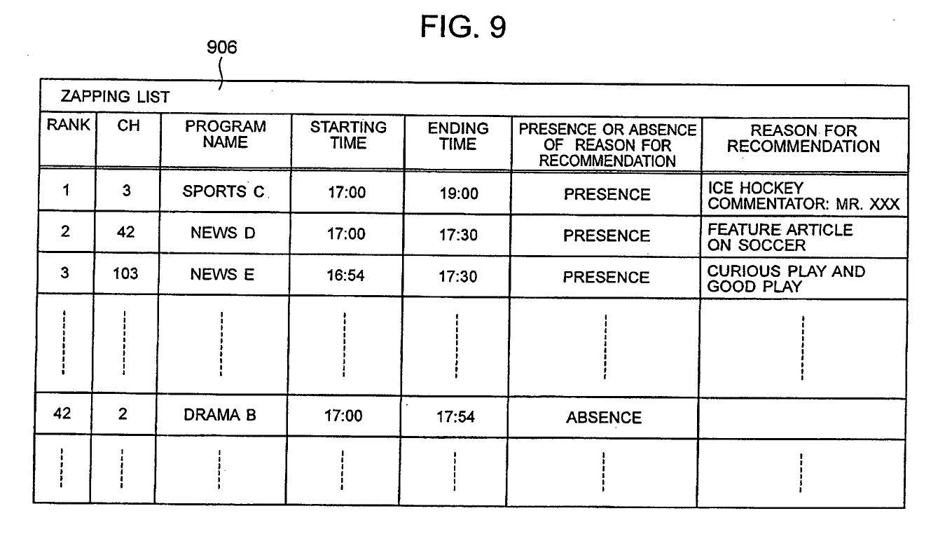

In FIG. 9 is shown an example of a zapping list 906. In the zapping list 906 are described the order of selection of channel, channel number, name of program, stating time, and ending time. Further, reasons for recommendation are also described for programs in higher ranks in the list. The reasons for recommendation are extracted at step S202. Frequency according to the degree of viewer's preference is allotted by a predetermined algorithm in the user profile for each information included in the program-related information 902 of the program viewed in the past by the viewer. For this reason, programs including the information of higher frequencies of the program-related information 902 acquired from the storing unit 107 at step S202 are arranged in the higher ranks of the zapping list 906. At step S202, the information of higher frequency is stored as reason for recommendation of the program for each program in the list.

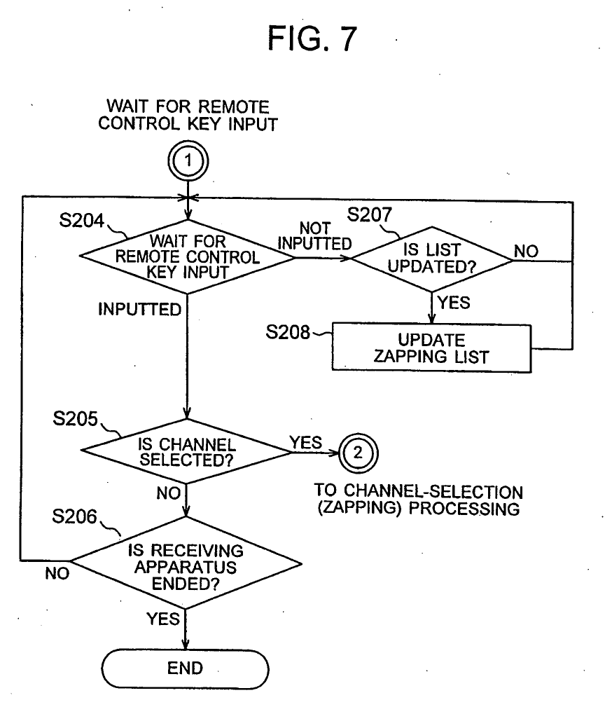

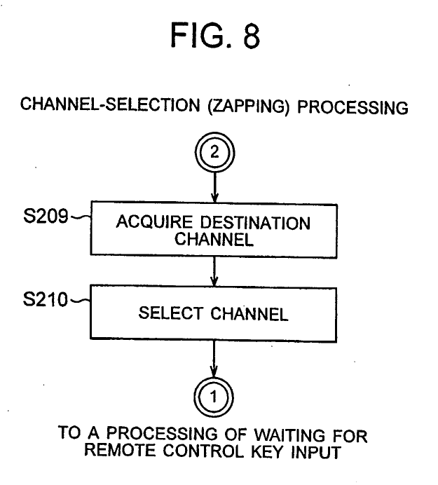

Here, while it is assumed that the user profile is previously generated, there is also a case where the user profile is generated when the receiving apparatus 10 is started. In this case, the user profile generating unit 110 generates a user profile and then the user profile is acquired by the list generating unit 109. The zapping list 906 is generated at step S202 and then the channel selecting unit 108 in the receiving apparatus 10 instructs the receiving unit 101 to select the channel of a program to be provided first (FIG. 6, step S203). The program to be provided first may be also a program having been viewed last time. Alternatively, the program may be also a program of the highest rank among the programs described in the zapping list 906. However, in the latter case, the channel selecting unit 108 needs to acquire the zapping list 906 from the list generating unit 109 before making a request to select a channel to the receiving unit 101. After step S203, the receiving apparatus 10 waits for remote control information 904 to be inputted (FIG. 7, step S204). If the remote control information 904 is not inputted for a predetermined period at step S204, the receiving apparatus 10 makes a determination of updating the zapping list 906 (FIG. 7, step S207). The zapping list 906 is updated when one program of the list is ended (or gets close to the end) (FIG. 7, step S208). In the example of the list shown in FIG. 9, the list is updated during the time period described in the item of “ending time”. In this case, the zapping list 906 is generated in the form including a program to start newly when the list is updated (or in a few minutes after the list is updated). Further, at step S207, the user profile generating unit 110 is checked to see whether or not the user profile is updated. If the user profile is updated, the zapping list 906 is updated aside from the update timing described above (FIG. 7, step S208). After this update, the updated user profile is used to update the zapping list 906. If the zapping list is not updated at step S207 or the zapping list 906 is updated at step S208, after that, the routine again returns to step S204 where the receiving apparatus 10 waits for the remote control information 906 to be inputted. If the remote control information is inputted from the viewer at step S204, in other words, if the remote control input unit 112 receives the remote control information 904, the remote control input unit 112 determines whether or not the remote control information 904 is information produced by pressing down the up/down key 401 (FIG. 7, step S205). If the remote control information 904 is not information produced by pressing down the up/down key 401, the remote control input unit 112 determines whether or not the remote control information 904 is information of a request to end the receiving apparatus 10 (FIG. 7, step S206). Here, if the remote control information 904 is information of a request to end the receiving apparatus 10, before the receiving apparatus 10 is ended, the receiving apparatus 10 abandons the zapping list 906 and updates the user history information 903 and stores the updated user history information 903 in the storing unit 107. If the remote control information 904 is not information of a request to end the receiving apparatus 10 at step S206, a predetermined processing is performed and then the routine again returns to step S204 where the receiving apparatus 10 waits the remote control information 904 to be inputted. If the remote control information 904 is information produced by the pressing down the up/down key 401 at step S205, the remote control input unit 112 transmits the remote control information 904 to the channel selecting unit 108. The channel selecting unit 108 having received the remote control information 904 acquires the zapping list 906 from the list generating unit 109 (FIG. 8, step S209) and specifies the program corresponding thereto (destination channel) and makes a request to select the destination channel to the receiving unit 101 (FIG. 8, step S210). Thereafter, the routine again returns to step S204 where the receiving apparatus 10 waits the remote control information 904 to be inputted. When the viewer performs the zapping operation, a series of processing from step S204 in FIG. 7 to step S210 in FIG. 8 are iterated.

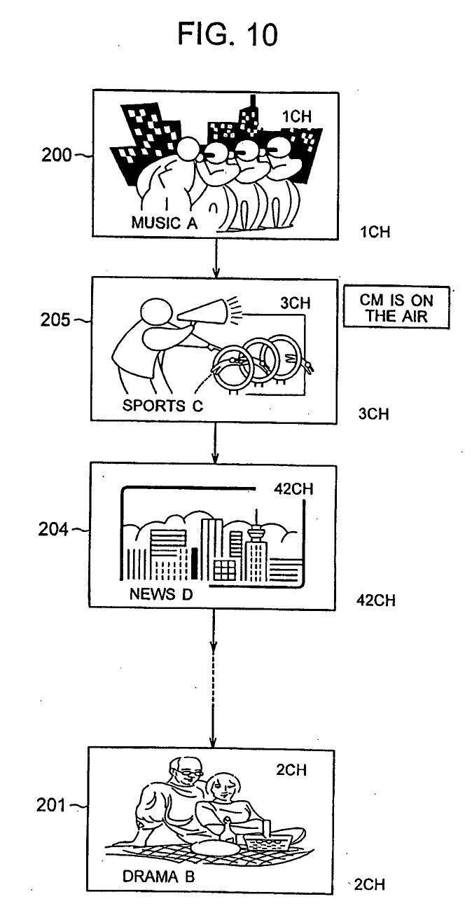

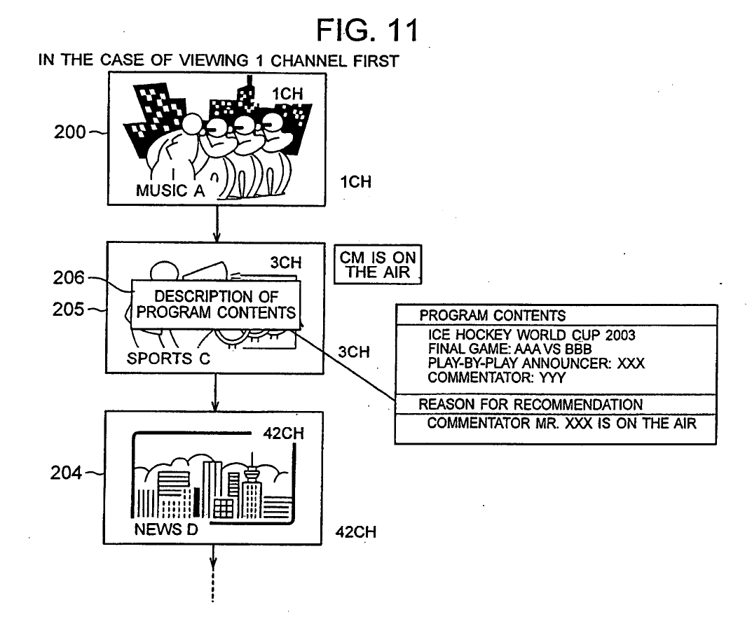

Next, a processing in the case where an image (for example, CM) that is not an image constructing a program is broadcast during a processing of selecting a channel on the basis the information of viewer's preference will be described. As shown in FIG. 10, when an image 205 of a channel in which CM is being broadcast is displayed during a zapping operation, the viewer falls into difficulty in grasping the contents of a program. For this reason, in this embodiment, as shown in FIG. 11, when the CM image is being broadcast, “other image” 206 such as description of the contents of program and reason for recommendation is dynamically inserted into the screen. Here, the reason for recommendation is added only to a program of higher rank in recommendation. The description of the program contents includes the description of the program, genre, performers, and program broadcast time. Hereafter, this processing will be described with reference to FIGS. 6, 7, and 12.

The processing (step S201 to step S203) at the time of starting the receiving apparatus 10, shown in FIG. 6, and the processing of waiting for the remote control information 904 to be inputted, shown in FIG. 7, step S204, are the same as the processing described above. However, the mode selected at the time of checking a mode at step S201 is a mode in which a channel in order of the decreasing degree of viewer's preference and in which a CM determination processing is effective.

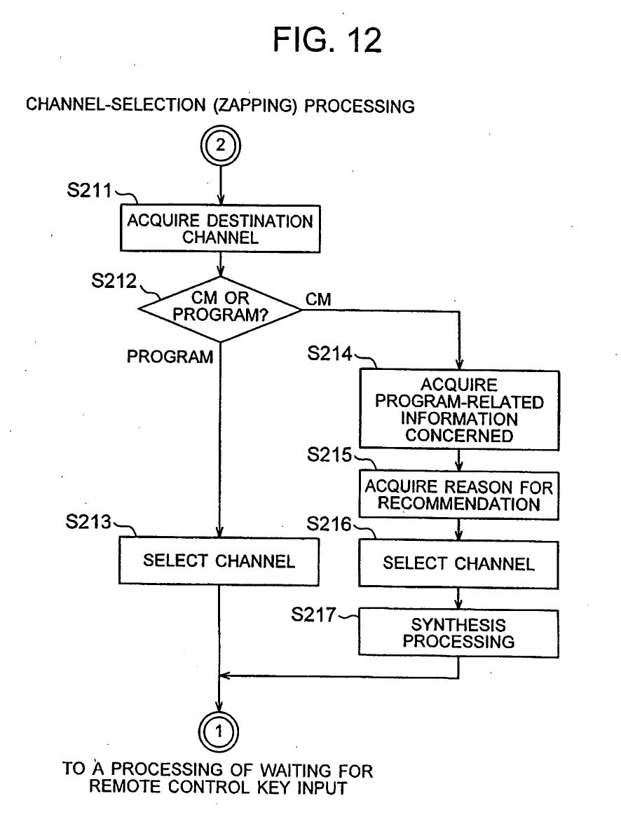

If the remote control information 904 is inputted at step S204 and it is determined that the information 904 is information inputted by pressing down the up/down key 401, the remote control input unit 112 sends the remote control information 904 to the channel selecting unit 108 (FIG. 7, step S205). The channel selecting unit 108 having received the remote control information 904 acquires the zapping list 906 from the list generating unit 109 (FIG. 12, step S211). Then, when the channel selecting unit 108 determines the program of the destination channel by the acquired zapping list 906 (selection step), the channel selecting unit 108 makes an inquiry about whether or the program is broadcasting CM to the program determining unit 106 (FIG. 12, step S212). The program determining unit 106 having received the inquiry acquires program scene information in the program-related information 902 stored in the storing unit 107 and determines whether or not the program is broadcasting CM (determination step). If it is determined at step S212 that the program is not broadcasting CM, just with the above case, the channel selecting unit 108 makes a request to select the channel of the program to the receiving unit 101 (FIG. 12, step S213). Thereafter, when step S213 is ended, the routine again returns to step S204 where the receiving apparatus 10 waits for the remote control information 904 to be inputted. If it is determined at step S212 that the program is broadcasting CM (that is, it is determined that the image of the selected channel is an image that is not an image constructing the program), the channel selecting unit 108 makes a request to output an image signal for displaying “other image” including information related to a program which is outputted by the selected channel or a program which is scheduled to be outputted by the selected channel, to the program information synthesizing unit 114. In this embodiment, the channel selecting unit 108 makes a request to combine the program information and the reason for recommendation with the image (CM) of channel and to output the combined result to the program information synthesizing unit 114. The program information synthesizing unit 114 having received the request extracts the program information of the program concerned from the program-related information 902 stored in the storing unit 107 (FIG. 12, step S214). Similarly, the program information synthesizing unit 114 acquires the reason for recommendation that is described in the zapping list 906 by the list generating unit 109 (FIG. 12, step S215). Here, the storing unit 107 and the list generating unit 109 construct a program-related information holding unit that holds information related to a program which is outputted or scheduled to be outputted by the channel selected. Then, the channel selecting unit 108 makes a request to select the channel of the program concerned to a receiving unit 101 and the receiving unit 101 receives the requested program (FIG. 12, step S216). Thereafter, at step S217, the screen synthesizing unit 104 generates an image signal of combining the character figure information, which shows the description of the program contents and the reason for recommendation received from the program information synthesizing unit 114, with the image from the receiving unit 1101 and outputs the image signal to the display unit 105 (output step). The description of the program contents and the reason for recommendation may be automatically brought out of display in a certain time or may be brought out of display by the viewer. Thereafter, when step S217 is ended, the routine again returns to step S204 where the receiving apparatus 10 waits for the remote control information 904 to be inputted.

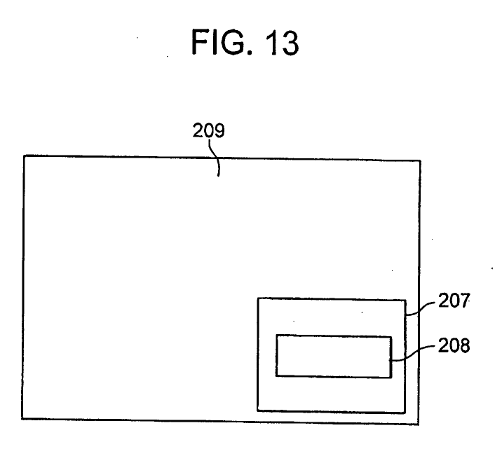

In the above-described output step, an outputted image signal is such that displays other image (in this embodiment, character figure information that shows the description of the program contents and the reason for recommendation) in at least part of the same display region as a display region where an image constructing a program is displayed when the image of the channel selected is the image constructing the program. For example, in the example shown in FIG. 11, the display region of the image 200 and the like constructing the program is the whole screen and the other image 206 is displayed in a portion (the center portion) of the display region (whole screen). Alternatively, like the example shown in FIG. 13, when an image constructing the program is displayed in a child screen 207 (in other words, the zapping operation is performed in the child screen 207), the other image 208 is displayed in a portion of the child screen 207 thereof. In the multiple screen display, the image of the program now being viewed is displayed in a display region (parent screen) 209 outside the child screen 207 in many cases. If the other image 208 is displayed in at least part of the child screen 207, it is possible to prevent the other image 208 from interfering with the viewing of an important image displayed in the display region 209 outside the child screen 207.

According to this embodiment, in a channel selection processing of performing a zapping operation in order of the decreasing degree of viewer's preference, when the image of a selected channel is a CM image, the description of the program contents is dynamically displayed to the viewer. Hence, the viewer is not required to wait for the CM to end nor required to display the description of the program contents by hand and hence can check the contents of the program within a short time. Further, since the contents of the program and the reason for recommendation can be displayed at the same time to the viewer, the viewer can judge the degree of preference for the program with more ease.

In this regard, while the CM image has been described here as an image that is not an image constructing the program, the image is not limited to the CM image. An image that is not an image constructing the program, for example, even an image of showing that a program can not be broadcast or a test pattern can also perform the same processing as described above and can produce the same effect.

Further, while the determination processing by the program determining unit 106 is performed by the information acquired from the program scene information in this embodiment, the determination processing is not limited to this. Other determination processing such as the direct determination of the contents of the program from the image and sound of the program content 901 can be used. For example, the switching of sound information between monophonic sound and stereophonic sound may be regarded as the switching of the contents of the program and may be used for the determination processing.

### Second Embodiment

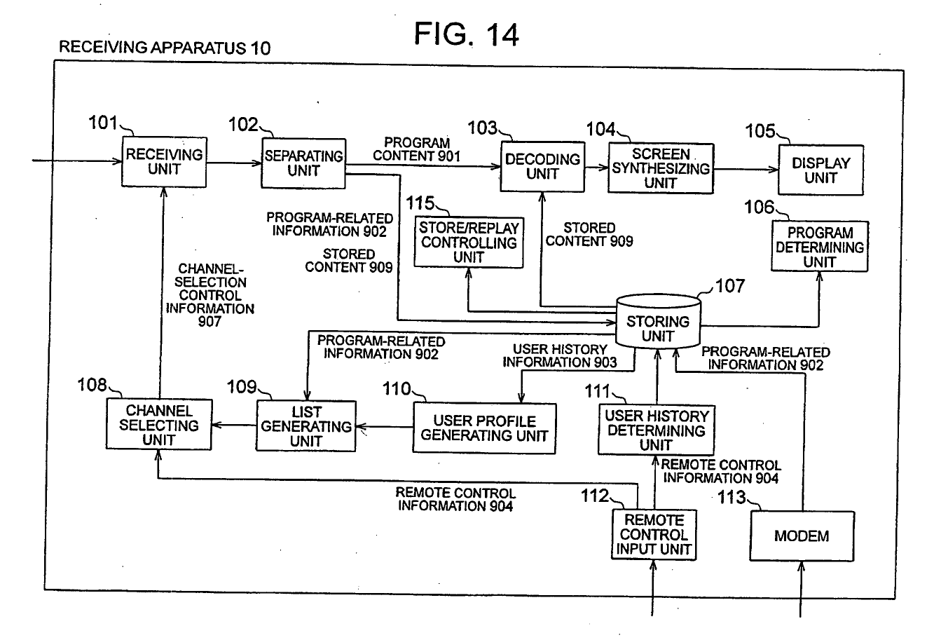

FIG. 14 is a block diagram to show the construction of a receiving apparatus 10 according to the second embodiment of the invention.

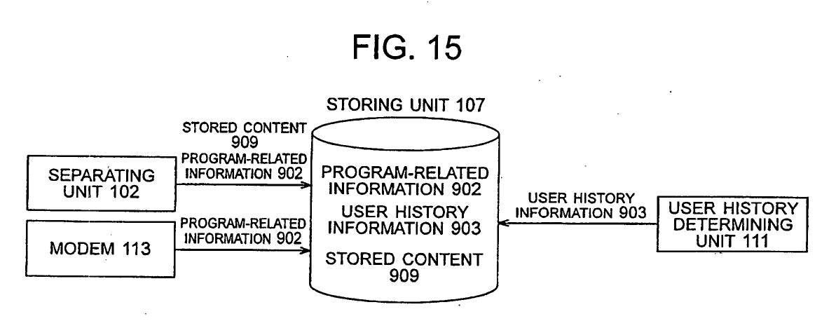

The construction common to the first embodiment is denoted by the same reference symbols and its description will be omitted and only the differences between the first and second embodiments will be described below. In this receiving apparatus 10, the receiving unit 101 can receive two programs at the same time. The separating unit 102 separates multiplexed broadcast data received through the receiving unit 101 and then sends the program content 901 for display to the decoding unit 103. On the other hand, the separating unit 102 sends the program-related information 902 separated from the program content 901 to the storing unit 107. Further, at the same time, the separating unit 102 sends also the program content 901 for storage (hereinafter referred to as stored content 909) to the storing unit 107. Here, it is thought that the storing unit 107 is a hard disk or a semiconductor memory but the storing unit 107 is not limited to the hard disk or the semiconductor memory. FIG. 15 shows the relationship between various kinds of information stored in the storing unit 107 and the respective parts to store them. As compared with the first embodiment, the stored content 909 is newly stored in the storing unit 107. Here, the storing unit 107 can be constructed of two or more different storage media to store the stored content 909 and information other than the stored content 909 in different storage media. Here, the storing unit 107 constructs an recording unit that records an image of a program.

The decoding unit 103 decodes the program content 901 separated by the separating unit 102 and passes the motion image information of the program content 901 to the screen synthesizing unit 104. Further, the decoding unit 103 passes the sound information of the program content 901 to the audio output unit (not shown). Further, similarly, the decoding unit 103 decodes also the stored content 909 stored in the storing unit 107 and passes the decode result to the screen synthesizing unit 104 and the audio output unit. When the screen synthesizing unit 104 receives two or more motion image information from the decoding unit 103, the screen synthesizing unit 104 combines them or switches between them.

A store/replay controlling unit 115 controls the storage and replay (reproduction) of the stored content 909 stored in the storing unit 107. When the list generating unit 109 generates the zapping list 906 at the time of the receiving apparatus 10 being started, the stored content 909 is automatically stored according to the list. The stored content 909 is reproduced when the viewer sends an instruction of replay via the remote controller 20 or when the channel selecting unit 108 makes a reproduction request, which will be described later. When the store/replay controlling unit 115 reproduces the stored content 909, the store/replay controlling unit 115 makes a request to decode the specified stored content 909 to the decoding unit 103. Further, when it is necessary to output the combination of the stored content 909 and the program content 901, the store/replay controlling unit 115 sends control information to be required to combine the stored content 909 with the program content 901 to the screen synthesizing unit 104. Further, the store/replay controlling unit 115 manages the stored content 909 and grasps the correspondence between the program now on the air and the stored content 909. Still further, when the program is ended and the zapping list 906 is updated, the store/replay controlling unit 115 automatically deletes the stored content 909 of the program that become unnecessary.

The remote control input unit 112, the user history determining unit 111, the user profile generating unit 110, the list generating unit 109, the channel selecting unit 108, and the program determining unit 106 are constructed in the same manner as in the first embodiment.

The viewer uses the remote controller 20 as operating means at the time of viewing the program. In addition to the same construction as in the first embodiment, a remote control key required to replay the stored content 909 is additionally provided in the remote controller 20.

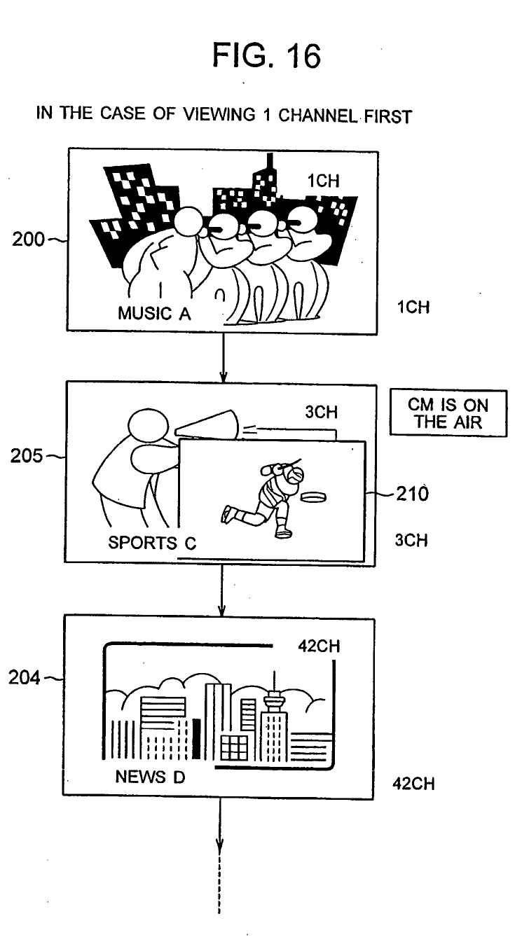

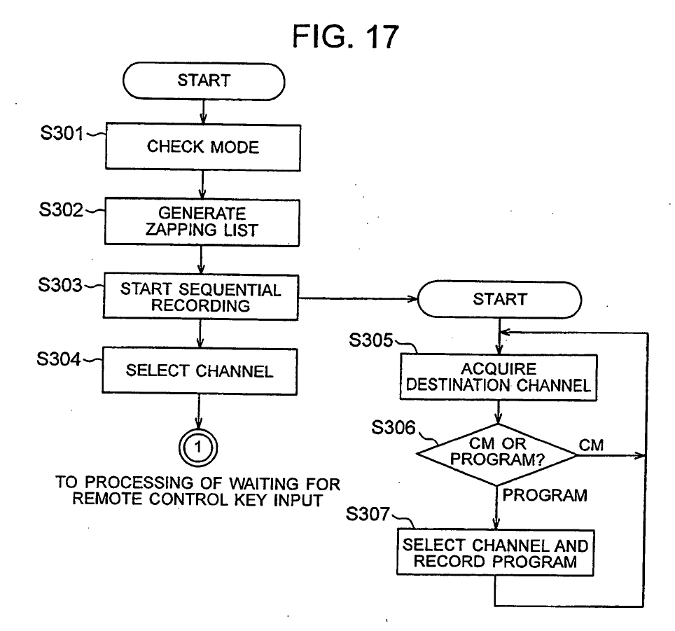

Next, a channel selection processing of the receiving apparatus 10 in this embodiment will be described. The state of the screen transition when the up/down key 401 of the remote controller 20 is continuously pressed down is the same as in the first embodiment. (refer to FIG. 4). In this embodiment, the state of display when a channel of an image (CM image or the like) that is not an image constructing the program is displayed during processing the zapping operation on the basis of the information of viewer's preference like this is shown in FIG. 16. Here, when the image of the selected channel is determined to be a CM image 205, an image 210 of a program that is outputted by the selected channel and has been previously stored (recorded) is displayed in the manner superimposed on the CM image 205. The image 210 having been previously stored is an image constructing the program. Here, in this case, the CM image 205 may be displayed as a child screen on the image 210 of the stored content 909. Further, only the image 205 of the stored content 909 may be displayed. Hereafter, this processing will be described by the use of FIGS. 17, 18 and 19.

FIG. 17 is a processing flow from the starting of the receiving apparatus 10 to the providing of the first TV program. When the viewer starts the receiving apparatus 10, the receiving apparatus 10 checks a mode (FIG. 17, step S301). There are a plurality of modes according to difference between the order of selection of channels when the zapping operation is performed by pressing down the up/down key 401 and whether or not a CM determination processing is effective. Here, a mode will be described in which channels are selected in order of the decreasing degree of viewer's preference and in which the CM determination processing is effective. When a mode is checked at step S301, at step S302, the list generating unit 109 in the receiving apparatus 10 acquires the user profile from the user profile generating unit 110 and the program-related information 902 from the storing unit 107 and generates the zapping list 906. The list generating unit 109 extracts a group of programs concerned from the program-related information 902 and then arranges the extracted group of programs in order of the decreasing degree of viewer's preference on the basis of the user profile, thereby generating the zapping list 906. The programs to become an object in the generation of the list may include not only the program now on the air but also a program scheduled to be started in a few minutes. The format of the zapping list 906 is the same as in the first embodiment (refer to FIG. 9). Thereafter, the receiving apparatus 10 starts sequential recording of the images according to the generated list (FIG. 17, step S303). The sequential recording means an operation of recording each program of a group of programs ranking higher in the zapping list 906 for a predetermined period in sequence. The number of programs to be recorded and a period of recording each program are set by the viewer. When the sequential recording is started at step S303, the channel selecting unit 108 instructs the receiving unit 101 to select the channel of a program to be displayed first (FIG. 17, step S304). Then, the receiving apparatus 10 waits for the remote control information 904 to be inputted.

A processing of sequential recording will be described. First, the store/replay controlling unit 115 acquires the zapping list 906 from the list generating unit 109 and determines a program to be recorded first in the list (FIG. 17, step S305). Usually, at first, a program ranking highest in the list is selected. Thereafter, programs are selected in order of the list. When the order of the list is changed because the list is updated or the like, the programs are selected again from the start of order of the list. When there is a program not yet to be recorded, the program is selected with higher priority. Then, an inquiry about whether or not the selected program is now broadcasting CM is made to the program determining unit 106 (FIG. 17, step S306). The program determining unit 106 having received the inquiry acquires the program scene information in the program-related information 902 stored in the storing unit 107 and determines whether or not the selected program is now broadcasting CM. If, at step S306, it is determined that the selected program is now broadcasting CM, the routine again returns to step S305 where a program to be recorded next is determined. If, at step S306, it is determined that the selected program is not broadcasting CM, the store/replay controlling unit 115 makes a request to select the channel of the program concerned to the receiving unit 101 and at the same time makes a request to change a output destination into the storing unit 107 to the separating unit 102 to start recording images (FIG. 17, step S307). The recording of images, which is started at step S307, is automatically stopped when a predetermined period is exceeded and then the routine again returns to step S305 where a program to be recorded next is determined. A series of processing of sequential recording from step S305 to step S307 are iterated until the viewer does not make a clear request to end the processing.

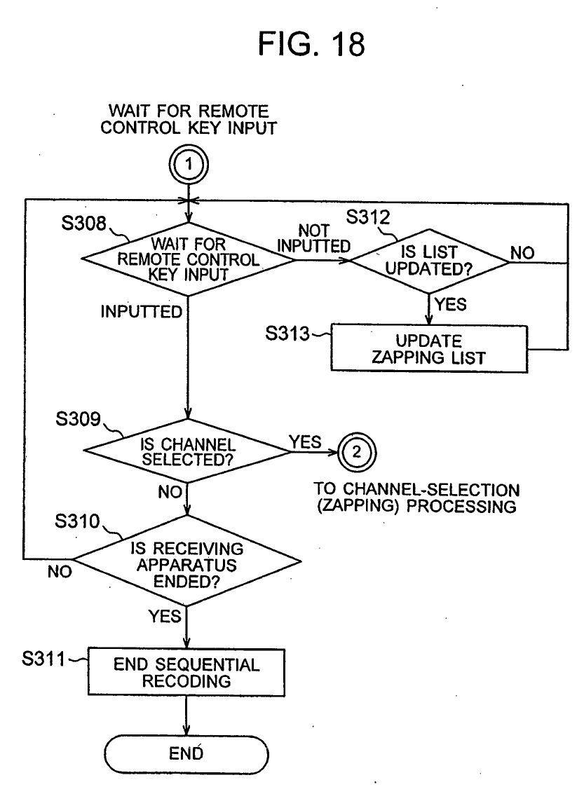

FIG. 18 shows a processing after the receiving apparatus 10 waiting for the remote control information 904 to be inputted. At step S308, the receiving apparatus 10 waits for the remote control information 904 to be inputted (FIG. 18, step S308). If the information is not inputted for a predetermined period, the receiving apparatus 10 determines whether or not the zapping list 906 is updated (FIG. 18, step S312). The zapping list 906 is updated when one program of the list is ended (or is close to ending) (FIG. 18, step S313). Further, at step 5312, the user profile generating unit 110 is checked to see whether or not the user profile is updated. If the user profile is updated, the zapping list 906 is updated apart from the update timing described above (FIG. 18, step S313). After this update, the updated user profile is used for updating the zapping list 906. If the zapping list 906 is not updated at step S312, or after the zapping list 906 is updated at step S313, the routine again returns to step S308 where the receiving apparatus 10 waits for the remote control information 904 to be inputted. If the remote control information 904 is inputted from the viewer at step S308, in other words, if the remote control input unit 112 receives the remote control information 904, the remote control input unit 112 determines whether or not the information is information related to the channel selection (FIG. 18, step S309). If the information is not information related to the channel selection, it is determined whether or not the information is a request to end the receiving apparatus 10 (FIG. 18, step S310). Here, if the information is a request to end the receiving apparatus 10, before the receiving apparatus 10 is ended, the receiving apparatus 10 abandons the zapping list 906 and the user profile and updates the user history information 903 and stores the updated user history information 903 in the storing unit 107. At the same time, the sequential recording is ended and the stored content 909 having recorded until then are deleted (FIG. 18, step S311). It is also recommended that if the viewer sets the stored content 909 to be stored, the stored content 909 is stored also after the receiving apparatus 10 is ended. If the information is not a request to end the receiving apparatus 10 at step S310, a predetermined processing is performed and then the routine again returns to step S308 where the receiving apparatus 10 waits for the remote control information 904 to be inputted.

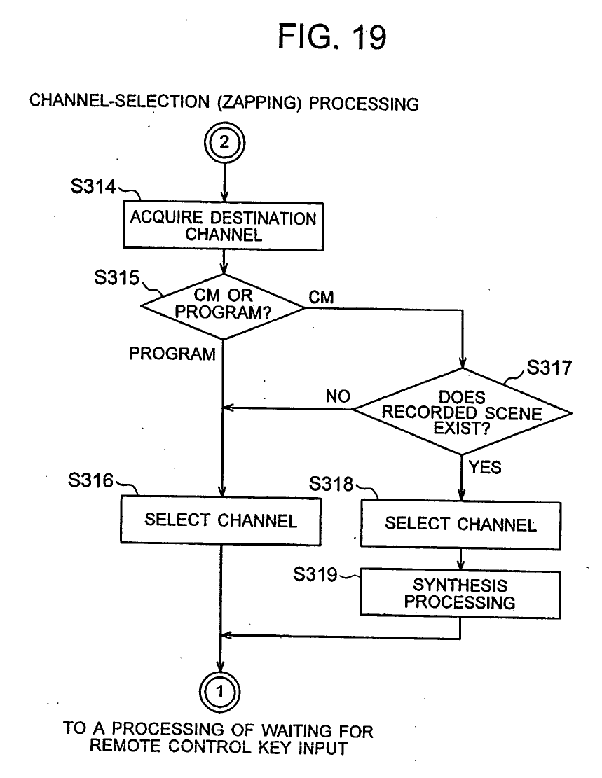

If the remote control information 904 is information related to the channel selection at step S309, the remote control input unit 112 transmits the remote control information 904 to the channel selecting unit 108. The channel selecting unit 108 having received the remote control information 904 acquires the zapping list 906 from the list generating unit 109 (FIG. 19, step S314). Then, when the channel selecting unit 108 determines the program concerned from the acquired zapping list 906 (selection step), the channel selecting unit 108 makes an, inquiry about whether or not the program concerned is now broadcasting CM to the program determining unit 106 (FIG. 19, step S315). If it is determined at step S315 that the program concerned is not broadcasting CM, the channel selecting unit 108 makes a request to select the channel of the program concerned to the receiving unit 101 (FIG. 19, step S316). Then, the routine again returns to step S308 where the receiving apparatus 10 waits for the remote control information 904 to be inputted. If it is determined at step S315 that the program concerned is now broadcasting CM (that is, when it is determined that the image of the selected channel is an image that is not an image constructing the program), the store/replay controlling unit 115 is checked to see whether or not the stored content 909 of the program concerned exists (FIG. 19, step S317, image-recording checking step). If the stored content 909 of the program concerned does not exist in the storing unit 107 at this point in time, the routine proceeds to step S316 where the channel selecting unit 108 makes a request to select the channel of the program concerned to the receiving unit 101. At this time, as shown in the first embodiment, the program information related to the program concerned may be displayed at the same time. On the other hand, if the stored content 909 exists already at this point in time, just with the case described above, the channel selecting unit 108 makes a request to select the channel of the program concerned to the receiving unit 101 (FIG. 19, step S318) and at the same time makes a request to combine the stored content 909 with the motion image of the program concerned and to output the combined result to the store/replay controlling unit 115 (FIG. 19, step S318). When the store/replay controlling unit 115 receives the request, it acquires the stored content 909 of the program concerned from the storing unit 107 and passes the stored content 909 to the decoding unit 103 to decode the stored content 909. Further, the screen synthesizing unit 104 generates an image signal in which the stored content 909 is combined with the program content 901 according to a predetermined setting and outputs the image signal to the display unit 105 (output step) That is, in this embodiment, when the image of the selected channel is an image that is not an image constructing the program, an image signal for displaying the recorded image of the program concerned is outputted as other image including information related to the program outputted by the selected channel. Here, there is a case where the replay time of the stored content 909 is shorter than the broadcast time of CM. In this case, the stored content 909 may be iteratively replayed or may be ended only once. Then, the routine again returns to step S308 where the receiving apparatus 10 waits for the remote control information 904 to be inputted. When the viewer performs the zapping operation, a series of processing from step S308 in FIG. 18 to step S316 or to step S319 in FIG. 19 are iterated.

According to this embodiment, in a channel selection processing of performing a zapping operation in order of the decreasing degree of viewer's preference, when the image of a selected channel is a CM image, by displaying the recorded image scene of the contents of a program dynamically, the viewer can obtain the same effect as in the first embodiment. Further, in the case where the recorded image of the program is long enough to see, the viewer can more easily grasp the synopsis or story before that time of the program, which is difficult to grasp by the conventional zapping operation. Still further, by the concurrent use of a replay function such as double-speed replay, the viewer can grasp, for example, long hours of program and a program whose theme changes for each corner.

Further, while the CM image has been taken and described as an image that is not an image constructing the program, as is the case with the first embodiment, the non-program images can be used.

Further, while the determination processing by the program determining unit 106 is such that is performed in this embodiment, just with the first embodiment, by using information acquired from the program scene information, the determination processing is not necessarily performed by the information but may be performed by the use of the other determination processing. For example, it is also recommendable to regard the switching between monophonic sound information and stereophonic sound information as the switching of the contents of the program and to use the switching for the determination processing.

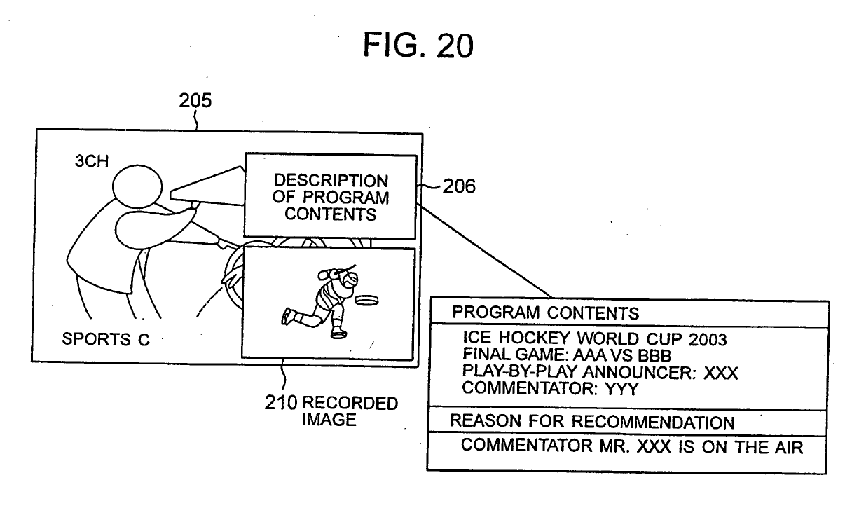

Still further, it is also recommendable to combine a recorded image showing program contents with a non-program image such as CM and at the same time to display the description of the program contents and the reason for recommendation of the program, which has been described in the first embodiment. An example of concurrent display is shown in FIG. 20. In this case, a child screen is a recorded image 210. An image 206 including the description of the program contents and the reason for recommendation is displayed outside the recorded image 210. Here, the image 206 of the description of the program contents and the like may be superimposed on the recorded image 210 for display. In this case, it is recommended that the image 206 be OSD-displayed in a translucent manner in such a way that the recorded image 210 can be recognized.

This application claims priority from Japanese Patent Application Nos. 2003-435664 filed Dec. 26, 2003 and 2004-345330 filed Nov. 30, 2004, which are hereby incorporated by reference herein.

1. A signal output method of outputting an image signal for displaying an image, the method comprising:
a selection step of selecting a channel according to a signal for giving an instruction of changing a channel; and
an output step of outputting an image signal for displaying other image when an image of the channel selected at said selection step is an image that is not an image constructing a program, said other image including information related to a program which is outputted or scheduled to be outputted by the channel selected,
wherein which channel is selected at said selection step is determined on the basis of information related to a usage history of an apparatus having a device for performing said selection step.

2. A signal output method according to claim 1, wherein said other image is a recorded image of a program that is outputted by the channel selected.

3. A signal output method according to claim 1, wherein said image that is not an image constructing a program is any one of an image of a commercial message, an image of showing that a program can not be broadcast, and a test pattern.

4. A signal output method according to claim 1, wherein said image signal outputted at the output step is such that displays said other image in at least part of the same display region as a display region where an image constructing a program is displayed when the image of the channel selected is the image constructing the program.

5. A channel selecting apparatus comprising:
a receiving circuit that receives a signal for giving an instruction of changing a channel;
a channel selecting circuit that selects a channel on the basis of a usage history of this channel selecting apparatus in response to reception of said signal by said receiving circuit; and
an output circuit that outputs an image signal for displaying other image when an image of the channel selected is an image that is not an image constructing a program, said other image including information related to a program which is outputted or scheduled to be outputted by the channel selected.

6. A channel selecting apparatus according to claim 5, further comprising a program-related information holding unit that holds said information related to a program which is outputted or scheduled to be outputted by the channel selected.

7. A channel selecting apparatus according to claim 5, further comprising a recording unit that records an image of a program, wherein said other image is a recorded image of a program that is outputted by the channel selected.

8. A program for outputting an image signal for displaying an image, the program comprising the steps of:
selecting a channel on the basis of a usage history of a channel selecting apparatus;
determining whether an image of the channel selected is an image that is not an image constructing a program; and
giving an instruction of outputting an image signal for displaying other image when an image of the channel selected is an image that is not an image constructing a program, said other image including information related to a program which is outputted or scheduled to be outputted by the channel selected.

9. A display method of selecting a signal path and displaying an image based on a signal received via the signal path, the method comprising a step of displaying assistance information capable of providing assistance to grasp of contents of a program when the signal received via the selected signal path is a signal for displaying a non-program image that is inserted just before or in midstream of a signal for displaying the program.

10. A display method according to claim 9, wherein said step includes a determination step of determining whether or not the signal received via the selected signal path is a signal for displaying a non-program image.
